(19) United States
(12) Patent Application Publication
(10) Pub. No.: US 2006/0108976 A1
(43) Pub. Date: May 25, 2006

(54) Non-contact charging device

(76) Inventor: Tiger Chen, Taipei (TW)

Correspondence Address: Tiger Chen, P.O. Box No. 6-57, Junghe, Taipei, 235, TW

(21) Appl. No.: 10/994,327

(22) Filed: Nov. 23, 2004

(51) Int. Cl. H02J 7/00

(52) U.S. Cl. 320/108

(57) ABSTRACT

A non-contact charging device includes a charging seat and a receiving end. The invention is characterized that, the charging seat is disposed with an active coil and a power circuit therein; and the receiving end is provided with an inductive coil, a conversion circuit and an electric cell at an interior thereof. Using the aforesaid structures, electric power is transmitted from the charging seat to the receiving end using electromagnetic induction by approaching the active coil with the inductive coil. Without requiring a design of connecting terminals, terminal damages and poor contact are prevented to reduce production cost.

### BACKGROUND OF THE INVENTION

(a) Field of the Invention

The invention relates to non-contact charging device, and more particularly, to a charge device without a design of connecting terminals, thereby preventing terminal damages or poor contact as well as reducing production costs.

(b) Description of the Prior Art

Accompanied with advancement of electronic techniques, consumer electronic devices are extensive spread with an overwhelming speed and applied in people's daily life. These consumer electronic devices include certain small electronic products such as cell phones, static digital cameras (DSC), personal digital assistants (PDA), laptops and MP3 walkmans. All of the above small electronic products are essentially being small in size and light in weight, and portable. That is, electric cells are required to offer such portability. In response to be environmental-friendly, huge amounts are rechargeable electric cells, commonly being nickel cadmium, nickel hydrogen and lithium electric cells, are used. It is obvious that corresponding charging devices are needed for all rechargeable electric cells.

Referring to FIG. 2, a prior charging device comprises a charging seat a and an electric cell b. The charging seat has an interior thereof provided with a charging circuit a1 connected with a plug a2 and an output terminal a3; wherein, the plug a2 and the output terminal a3 are disposed at an exterior of the charging seat a. The electric cell b is located within an electronic product c, and is connected with an input terminal b1 disposed at an exterior of the electronic product c.

According to the aforesaid structure, the plug a2 of the prior charging device is plugged into a socket providing power supply, such that an alternating current from the socket is forwarded into the charging circuit a1, which converts the alternating current into a direct current further passed to the output terminal a3. When electricity in the electric cell b in the electronic product c is consumed, the output terminal a3 is connected with the input terminal b1 of the electronic product c. Using connection between the output terminal a3 and the input terminal b1, the direct current is forwarded into and the electric cell b to charge the electric cell b.

However, to enable the charging device to charge the electric cell b in the electric product c, electric power is only transmitted by connecting the output terminal a3 with the input terminal b1. Furthermore, in order to transmit electric power, the output terminal a3 and the input terminal b1 have areas that come into contact with each other made of metal materials. It is to be noted that metal materials are prone to oxidation forming oxide layers at surfaces, and the oxide layers are electrically insulating. Therefore, poor contact is resulted between the output terminal and the input terminal to undesirably affect electric power transmission.

Moreover, wear to the output terminal and the input terminal is brought about by frequent plugging and unplugging and hence again causing poor contact between the output terminal and the input terminal.

Above all, the prior charging device is necessarily provided with an output terminal and an input terminal, which both increase production costs to lower market competitiveness.

### SUMMARY OF THE INVENTION

In the view of the aforesaid drawbacks of the prior invention, it is essential task of the invention as how to provide a novel charging device capable of overcoming the aforesaid drawbacks.

The primary object of the invention is to provide a non-contact charging device without a design of connecting terminals, thereby preventing terminal damages or poor contact as well as reducing production costs.

To accomplish the aforesaid object, a non-contact charging device according to the invention comprises a charging seat and a receiving end; and is characterized that, the charging seat is disposed with a power circuit and an active coil therein, and the receiving end is provided with a conversion circuit, an electric cell and an inductance coil.

Using to the aforesaid structure, the receiving end of the non-contact charging device according to the invention is placed onto the charging seat to locate the active coil approaching the inductance coil, such that electric power is transmitted through air from the power circuit to the conversion circuit using electromagnetism induction. Thus, the conversion circuit is enabled to charge the electric cell without a design of connecting terminals, thereby preventing terminal damages and poor contact as well as reducing production costs.

### BRIEF DESCRIPTION OF THE DRAWINGS

FIG. 1 shows a circuit block diagram according to the invention.

FIG. 2 shows a circuit block diagram of a prior charging device.

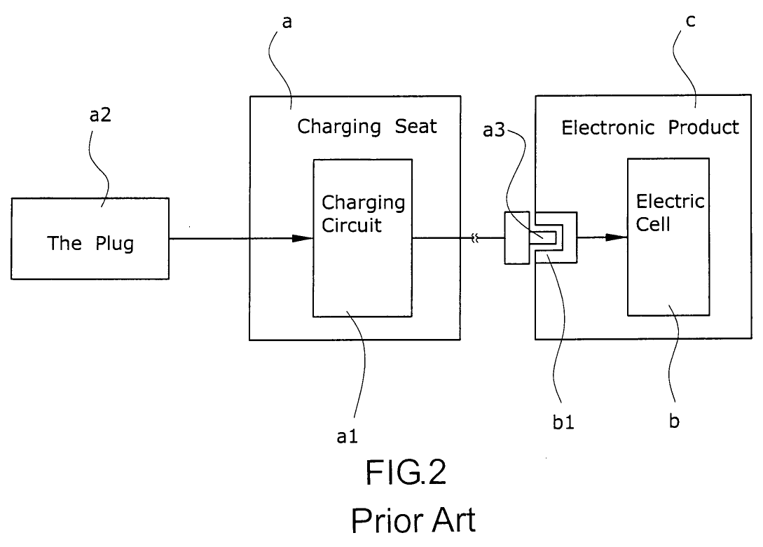

### DETAILED DESCRIPTION OF THE PREFERRED EMBODIMENTS

To better understand structures, devices and characteristics of the invention, detailed descriptions of a preferred embodiment shall be given with the accompanying drawing below.

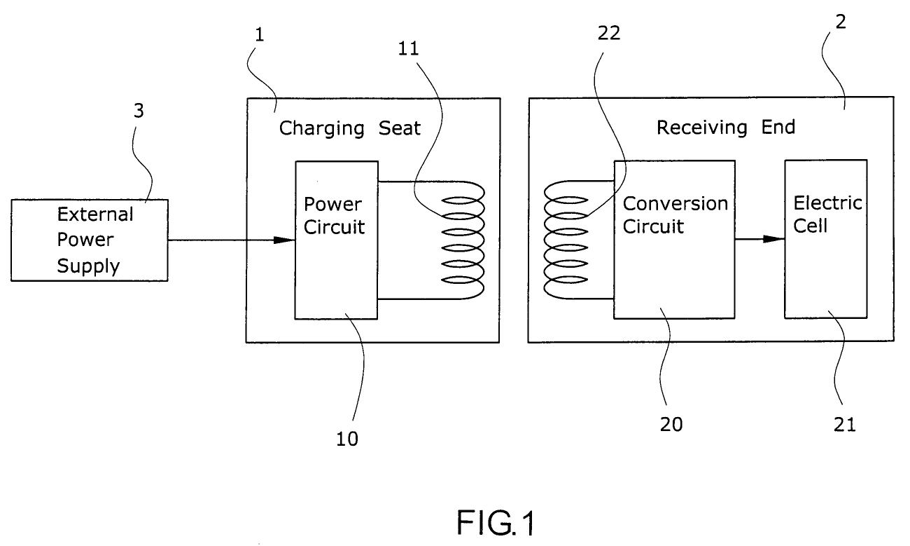

Referring to FIG. 1, a non-contact charging device according to the invention comprises a charging seat 1 and a receiving end.

The invention is characterized that, the charging seat 1 is devised with a power circuit 10 and an active coil 11 therein, wherein the power circuit 10 is connected with the active coil 11 and an external power supply 3; and the receiving end 2 is provided within an electronic apparatus, and has a conversion circuit 20, an electric cell 21 and an inductive coil 22 at an interior thereof; wherein, the conversion circuit 20 is connected with the electric cell 21 and the inductive coil 22, and the inductive coil 22 is corresponded with the active coil 11.

Using the aforesaid structures, the power circuit 10 of the non-contact charging device according to the invention allows an alternating current from the external power supply 3 to pass through the active coil 11, which emits electromagnetic waves when an alternating current passes through. On basis of Faraday's low of electromagnetic induction, electromagnetic forces from induction are formed around the inductive coil 22 when the active coil 11 approaches the inductive coil 22. Driven by the inductive electromagnetic forces, the inductive coil 22 produces an alternating current, which is forwarded into the conversion circuit 20 and converted into a direct current using the conversion circuit 20, thereby charging the electric cell 21 using the direct current formed.

As described above, using the non-contact charging device according to the invention, through the inductive electromagnetic forces formed around the inductive 22 at the receiving end 2 from electromagnetic waves produced by the active coil 11 in the charging seat 1 when the receiving end 2 approaches the charging seat 1, electric power is transmitted from the power circuit 10 to the conversion circuit 20 through air using electromagnetic induction, thereby constantly transmitting electric currents in absence of any circuits and joints to charge the electric cell 21 with the direct current converted from the alternating current using the conversion circuit 20. Without requiring any connecting terminals, terminal damages and poor contact are prevented to reduce production costs.

Conclusive from the above, without requiring contact terminals, the non-contact charging device is capable of preventing terminal damages and poor contact to reduce production costs. It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A non-contact charging device comprising a charging seat and a receiving end; and
being characterized that, the charging seat is disposed with a power circuit and an active coil therein, wherein the power circuit is connected with an external power supply; and the receiving end is provided with a conversion circuit, an electric cell and an inductance coil, wherein the conversion circuit is connected with the electric cell and the inductive coil, and the inductive coil is corresponded with the active coil; and
accordingly, the inductive coil receives electromagnetic forces from the active coil to produce an alternating current converted into a direct current using the conversion circuit, and the direct current formed is used to charge the electric cell.
